(19) United States
(12) Patent Application Publication
(10) Pub. No.: US 2011/0276490 A1
(43) Pub. Date: Nov. 10, 2011

(54) SECURITY SERVICE LEVEL AGREEMENTS WITH PUBLICLY VERIFIABLE PROOFS OF COMPLIANCE

(75) Inventors: Jiahe Helen Wang, Redmond, WA (US); Raluca Ada Popa, Boston, MA (US); Jacob Lorch, Bellevue, WA (US); Li Zhuang, Los Altos, CA (US); David Molnar, Seattle, WA (US)

(73) Assignee: MICROSOFT CORPORATION, Redmond, WA (US)

(21) Appl. No.: 12/775,666

(22) Filed: May 7, 2010

(51) Int. Cl. G06Q 10/00; H04L 9/00; G06Q 20/00; G06Q 50/00; G06F 21/00

(52) U.S. Cl. 705/50; 380/277; 705/317

(57) ABSTRACT

Techniques are described herein that are capable of providing security guarantees in security service level agreements (SLAB). For instance, a security SLA may specify a level of service to be provided to a user with respect to at least one security property (e.g., confidentiality, integrity, write-serialization, read freshness, etc.). Attestations may be used to prove occurrence (or non-occurrence) of violations of security properties in a manner that is universally verifiable, e.g., by third parties. An attestation is an indicator that is generated by a user to certify that the user makes a request (e.g., get request or put request) or an indicator that is generated by a cloud service provider to certify that the cloud service provider accurately fulfills a request of a user. A security SLA may specify a payment to be made to a user in response to an occurrence of a violation of a security property.

### BACKGROUND

Storing data with cloud storage providers traditionally comes with substantial security risks. A cloud storage provider can leak confidential data, modify the data, or return inconsistent data to different users. This may happen due to bugs, crashes, operator errors, or misconfigurations. Furthermore, malicious security breaches can be much harder to detect or damaging than accidental security breaches. For instance, malicious security breaches may be performed by external adversaries penetrating the cloud storage provider or employees of the cloud service provider committing an insider attack. Such concerns often prevent security-conscious enterprises and consumers from using cloud storage, despite its benefits.

Given the uncertainty over risks of cloud storage, issues of trust pose a significant barrier to the adoption of a storage model with economies of scale that promise extensive resources, scalability, and availability with substantial cost savings. Conventional cloud storage services (e.g., Amazon's Simple Storage Service™ (S3), Google's BigTable™, Hewlett-Packard's Cirious™, Microsoft's Azure®, Nirvanix's CloudNAS®, etc.) do not provide security guarantees in their service level agreements (SLAs). For example, Amazon S3's SLA merely guarantees availability (at a rate of 99.9%). In accordance with this example, when the cloud service is not available, clients are reimbursed a contractual sum of money. The same holds true of Microsoft's Azure's SLA, which merely guarantees that, 99.9% of the time, the cloud service will receive and successfully process correctly-formatted client requests.

As cloud storage moves toward a commodity business, security will be a key way for cloud service providers to differentiate themselves and provide value. However, cloud service providers face challenges in trying to prove that their security is better than their competitors. One conventional technique for measuring the security of a cloud service provider is to wait for a failure of that provider's security. For instance, a news outlet may report the failure. This technique is rather unpredictable and tends to merely weed out the worst of the worst cloud service providers. Another conventional technique for measuring the security of a cloud service provider is to perform a one-time audit of the cloud service provider's facilities. However, auditing a provider's facilities is a time-consuming and highly manual process. Furthermore, it will not detect intermittent problems that do not happen to manifest during the audit.

### SUMMARY

Various approaches are described herein for, among other things, providing security guarantees in security service level agreements (SLAs). For instance, a security SLA may specify a level of service to be provided to a user with respect to at least one security property (e.g., integrity, write-serialization, and/or read freshness). In accordance with this example, the security SLA may further specify that the cloud service provider is to pay the user an agreed-upon compensation in the event that security of the user's data is breached as defined by the security guarantee.

Violations of security properties may be proved based on attestations. An attestation is an indicator that is generated by a user to certify that the user makes a request (e.g., a get request or a put request) or an indicator that is generated by a cloud service provider to certify that the cloud service provider accurately fulfills a request of a user. For instance, the attestation may be said to bind a user to a request or to bind a cloud service provider to a specified state of data. Attestations may be exchanged between a user and a cloud service provider in an all-or-nothing fashion. The attestations may be analyzed to detect whether a security property has been violated with respect to the user's data. Violations of security properties may be proven in a manner that is universally verifiable, e.g., by third parties.

An example method is described in which a security service level agreement (SLA) is provided that includes a provision for a provider of a cloud service to compensate a user of the cloud service for a violation of a security property with respect to the cloud service. A payment to the user is initiated for the violation of the security property in response to the violation being programmatically proven in a manner that is universally verifiable.

Another example method is described in which an occurrence of a violation of a security property with respect to a cloud service is detected. The occurrence of the violation of the security property is proven in a manner that is universally verifiable.

Yet another example method is described in which a key that is associated with a family of blocks is generated in accordance with a key rotation technique. A family of blocks is a plurality of blocks that are associated with a common access control list (ACL). The key is encrypted in accordance with a broadcast encryption technique to provide a family key block. The family key block corresponds to an ACL that specifies a first subset of users of a cloud service that is to have read access to the family of blocks and a second subset of the users of the cloud service that is to have write access to the family of blocks. The family key block is provided with respect to the cloud service. For example, the family key block may be stored such that the family key block is accessible to all users of the cloud service. A block in the family of blocks is encrypted using the key to provide an encrypted block. The encrypted block is provided with respect to the cloud service.

An example system is described that includes an SLA provider and a payment module. The SLA provider is configured to provide an SLA that includes a provision for a provider of a cloud service to compensate a user of the cloud service for a violation of a security property with respect to the cloud service. The payment module is configured to initiate a payment to the user for the violation of the security property in response to the violation being programmatically proven in a manner that is universally verifiable.

Another example system is described that includes a violation detector and a proving module. The violation detector is configured to detect an occurrence of a violation of a security property with respect to a cloud service. The proving module is configured to prove the occurrence of the violation of the security property in a manner that is universally verifiable.

Yet another system is described that includes a key generator, a key encryption module, and a block encryption module. The key generation module is configured to generate a key that is associated with a family of blocks in accordance with a key rotation technique. The encryption module is configured to encrypt the key in accordance with a broadcast encryption technique to provide a family key block. The family key block corresponds to an ACL that specifies a first subset of users of a cloud service that is to have read access to the family of blocks and a second subset of the users of the cloud service that is to have write access to the family of blocks. The key encryption module is further configured to provide the family key block with respect to the cloud service. The block encryption module is configured to encrypt a block in the family of blocks using the key to provide an encrypted block. The block encryption module is further configured to provide the encrypted block with respect to the cloud service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example cloud service system in accordance with an embodiment.

FIG. 2 depicts example configurations of blocks in accordance with an embodiment.

FIGS. 3-5 depict example attestations in accordance with embodiments.

FIG. 6 depicts a flowchart of an example method for compensating a user for a violation of a security property with respect to a cloud service in accordance with an embodiment.

FIG. 7 is a block diagram of an example implementation of a cloud service provider shown in FIG. 1 in accordance with an embodiment.

FIG. 8 depicts a flowchart of an example method for proving an occurrence of a violation of a security property in accordance with an embodiment.

FIGS. 9 and 12 are block diagrams of example implementations of a user system shown in FIG. 1 in accordance with embodiments.

FIG. 10 depicts a flowchart of an example method for auditing a cloud service in accordance with an embodiment.

FIG. 11 depicts a flowchart of an example method for accessing a block in accordance with an embodiment.

FIG. 13 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments

Example embodiments described herein are capable of providing security guarantees in security service level agreements (SLAs). An SLA is a service contract that specifies a level of service to be provided to a user. A security SLA is an SLA that provides a security guarantee (i.e., the SLA specifies a level of service to be provided to a user with respect to at least one security property). For example, a cloud service provider and a user of the cloud service may enter into a security SLA under which the user stores its data with respect to the cloud service in return for the cloud service provider's guarantee of an agreed-upon level of service. The security SLA may specify that the user is to pay a fee to the cloud service provider that is based on the agreed-upon level of service. The security SLA may further specify that the cloud service provider is to pay the user an agreed-upon compensation in the event that security of the user's data is breached as defined by the security guarantee.

A security guarantee may be provided to a user of a cloud service with respect to any suitable security property. Four example security properties of cloud storage are discussed herein for illustrative purposes and are not intended to be limiting. These example security properties are integrity, write-serialization, and read freshness. Confidentiality means that the cloud service or any illegitimate (i.e., unauthorized) user cannot identify the contents of any blocks (i.e., groupings of data) that are stored by the user with respect to the cloud service. Integrity means that each read (a.k.a. get) operation returns the data that is written (a.k.a. put) by a legitimate user. For example, neither the cloud service nor unauthorized users are allowed to replace the data with different data. Freshness means that each read returns the data that was written by the most recent committed write operation. Write-serialization means that each user that provides an update with respect to a block is aware of the most recent committed update to the same block. Write-serialization implies that writes to the same block are ordered. For instance, the cloud service is not allowed to ignore a user's updates to a block.

In accordance with example embodiments, proofs of violations of security properties are based on attestations. An attestation is an indicator that is generated by a user to certify that the user makes a request (e.g., a get request or a put request) or an indicator that is generated by a cloud service provider to certify that the cloud service provider accurately fulfills a request of a user. For instance, the attestation may be said to bind a user to a request or to bind a cloud service provider to a specified state of data. For certain requests that a user provides to a cloud service provider, the user and the cloud service provider may exchange attestations in an all-or-nothing fashion, though the scope of the example embodiments is not limited in this respect. The attestations may be analyzed to detect whether a security property (e.g., integrity, write-serialization, freshness, etc.) has been violated with respect to the user's data. Violations of security properties may be proven in a manner that is universally verifiable, e.g., by third parties.

It should be noted that throughout this document, the term “prove” is intended to mean “prove to be factually true”, rather than “prove the appearance of being true”. For instance, proving a violation of a security property means that the violation did, in fact, occur.

Example embodiments described herein have a variety of benefits as compared to conventional cloud services and security level agreements. For instance, example embodiments are capable of detecting and/or proving violations of integrity, freshness, and/or write-serialization. Example embodiments provide highly-scalable read and write access control performed primarily by a cloud service in a verifiable way. For instance, cryptographic tools such as unique signatures, key rolling, and broadcast encryption may be used to enable delegation of access control, key distribution, read, write, file creation, and/or ensuring security properties to a cloud service. Example embodiments preserve concurrency and scalability for enterprise sizes.

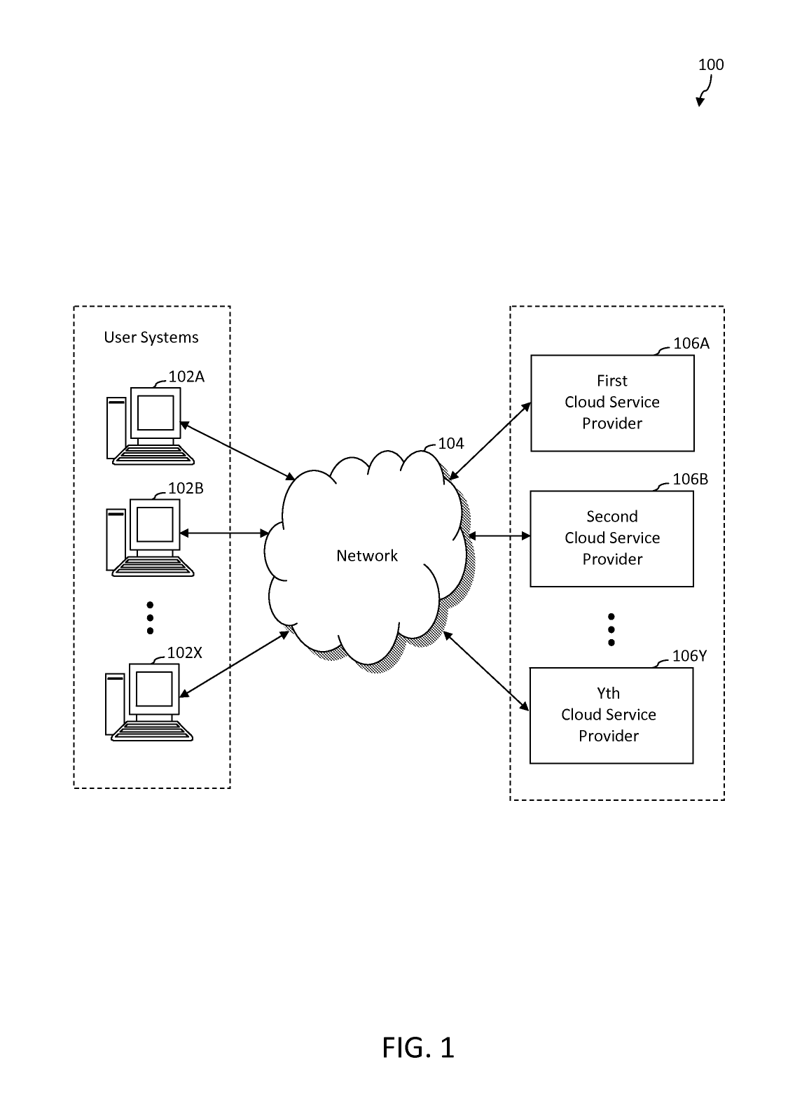

FIG. 1 is a block diagram of an example cloud service system 100 in accordance with an embodiment. Generally speaking, cloud service system 100 operates to provide network-based (e.g., Internet-based) computing to users of a cloud service. As shown in FIG. 1, cloud service system 100 includes a plurality of user systems 102A-102X, a network 104, and a plurality of cloud service providers 106A-106Y. Communication among user systems 102A-102X and cloud service providers 106A-106Y is carried out over network 104 using well-known network communication protocols. Network 104 may be a wide-area network (e.g., the Internet), a local area network (LAN), another type of network, or a combination thereof.

Cloud service providers 106A-106Y are processing systems that are capable of communicating with user systems 102A-102X. An example of a processing system is a system that includes at least one processor that is capable of manipulating data in accordance with a set of instructions. For instance, a processing system may be a computer, a personal digital assistant, etc. Cloud service providers 106A-106Y are configured to provide cloud services to user systems 102A-102X. Accordingly, cloud service providers 106A-106Y store and/or process data with respect to the cloud services in accordance with instructions that are received from user systems 102A-102X. To that end, cloud service providers 106A-106Y are configured to fulfill get (a.k.a. read) and put (a.k.a. write) requests that are received from user systems 102A-102X. For example, a cloud service provider 106 may provide data to a user system 102 in response to receiving a get request for the data from the user system 102. In another example, a cloud service provider 106 may store data with respect to a cloud service or update data that is stored with respect to the cloud service as specified in a put request that is received from a user system 102.

User systems 102A-102X are processing systems that are capable of communicating with cloud service providers 106A-106Y. User systems 102A-102X are configured to provide get and put requests to cloud service providers 106A-106Y for the purpose of using cloud services that are provided by the cloud service providers 106A-106Y. For instance, a user may initiate a get or put request using a client (e.g., a Web browser, Web crawler, non-Web-enabled client, etc.) deployed on a user system 102 that is owned by or otherwise accessible to the user. For example, a user system 102 may provide a get request to a cloud service provider 106 to read data that is stored with respect to a cloud service that is provided by the cloud service provider 106. In another example, a user system 102 may provide a put request to a service provider 106 to write data with respect to a cloud service (e.g., to update data that is stored with respect to the cloud service) that is provided by the cloud service provider 106. For instance, creation of a file may be performed using a put request. Deletion of a file may be performed using a put request for an empty file (e.g., with metadata equal to zero).

Although user systems 102A-102X are depicted as desktop computers in FIG. 1, persons skilled in the relevant art(s) will appreciate that user systems 102A-102X may include any suitable system or device, including but not limited to a laptop computer, a personal digital assistant, a cellular telephone, etc. Moreover, data that is stored with respect to a cloud service need not necessarily be stored on a cloud service provider 106 that provides that cloud service. For instance, the data may be accessible via the cloud service provider 106 but stored elsewhere.

It will be recognized that any one or more user systems 102A-102X may communicate with any one or more cloud service providers 106A-106Y. For instance, a user system 102 may provide a get or put request to any one or more cloud service providers 106A-106Y for purposes of using cloud services that are provided by the respective cloud service providers 106A-106Y. It will be further recognized that, although some operations are described herein as being performed by a user or a cloud service for ease of discussion, such operations may be performed by a respective user system 102 or cloud service provider 106.

A user of a cloud service may own data that is stored with respect to the cloud service. Such a user is referred to as a data owner with respect to that data; whereas, users who do not own the data but who have read and/or write access rights to the data are referred to as data users with respect to the data. A data owner may be an enterprise with business data or a home user with personal data. A data user may be an employee of an enterprise or a family member or friend of a home user. A data owner may have privileges with respect to its data that other users do not. For example, the data owner may determine access control policies with regard to the data. In accordance with this example, the data owner may change read and/or write access permissions of the users. The data owner (or other party) may audit a cloud service with respect to which the data of the data owner is stored to determine whether security of the data has been breached.

Data is described herein in terms of blocks for illustrative purposes and is not intended to be limiting. A block is a specified amount of data (e.g., 4 kilobytes, 16 kilobytes, etc.). The amount of data that constitutes a block may be adjustable, though the scope of the example embodiments is not limited in this respect. Each block is associated with an access control list (ACL). An ACL is a list that includes a first set of entities that may read a block with which the ACL is associated and a second set of entities that may write the block. Each entity is a user or a group of users. If a group has access to a block, and a user is added to or removed from that group, then that user gains or loses access to that block. The data owner may be the only user that is allowed to change the ACL of a block.

A block family is a plurality of blocks that are associated with a common ACL. If the owner of a block changes its ACL, the block is removed from its former block family and added to the block family that is associated with the new (e.g., updated) ACL. Accordingly, a common key may be used for all blocks in a block family to enforce access control to the block family.

Processing may be offloaded from a user system 102 to a cloud service provider 106 while maintaining security using cryptographic tools, including but not limited to broadcast encryption and key rotation. Broadcast encryption is a cryptographic technique in which a data owner encrypts a message that is to be provided to a subset of the users. Only authorized users in the subset are able to decrypt the message. For instance, the broadcast encryption technique may have O(\sqrt{n}) complexity to encrypt a message, where n is a number of users that are authorized to decrypt the message. In accordance with example embodiments, n is a number of users who have read access and/or write access to a block. Key rotation is a cryptographic technique in which a sequence of keys is produced from an initial key using a secret master key. Only the owner of the secret master key can produce the next key in the sequence, but any user knowing a key in the sequence can produce all earlier versions of the key.

To hinder or prevent unauthorized read operations, data that is stored with respect to a cloud service may be encrypted using a stream cipher, such as Advanced Encryption Standard (AES) in counter mode. The secret key of the cipher may be referred to as the read/get access key. Users that have read access can obtain the key for decryption as described in further detail below and thus are able to access the data. It should be noted that blocks in the same block family use the same read access key.

Write access control may be achieved with a public key signature technique. Each block family is associated with a public verification key and a private signing key. The public verification key may be known to all users and to the cloud service with respect to which the block family is stored. The signing key may be known only to users that are granted write access by the ACL. Each time a data user modifies a block, that data user computes its integrity signature using the signing key. An integrity signature is a signature over a hash of an updated block. The data user sends the integrity signature along with a write request to a cloud service provider 106 that provides the cloud service. The cloud service provider 106 stores the integrity signature along with the block. The cloud service provider 106 provides the integrity signature to users that read the block, so that the users can verify the integrity of the block.

Because the verification key is known to the cloud service provider 106, the cloud service provider 106 is able to perform write access control. Whenever a user attempts to update the block, the cloud service provider 106 verifies the integrity signature and allows the update only if the integrity signature is valid. If the cloud service provider 106 mistakenly allows a write without a valid integrity signature, this failure is detected by future data users who read the block. Attestations, which are described in detail below, allow those data users to prove the misbehavior of the cloud service provider 106.

For each block family, the data owner of the block family provides a block with respect to the cloud service that includes the key information for that block family. This block is referred to as the family key block. For instance, only the data owner may be allowed to modify the family key block. Because, by the definition of block family, all blocks in a family share the same ACL, each family key block corresponds to an ACL that all blocks in its family share.

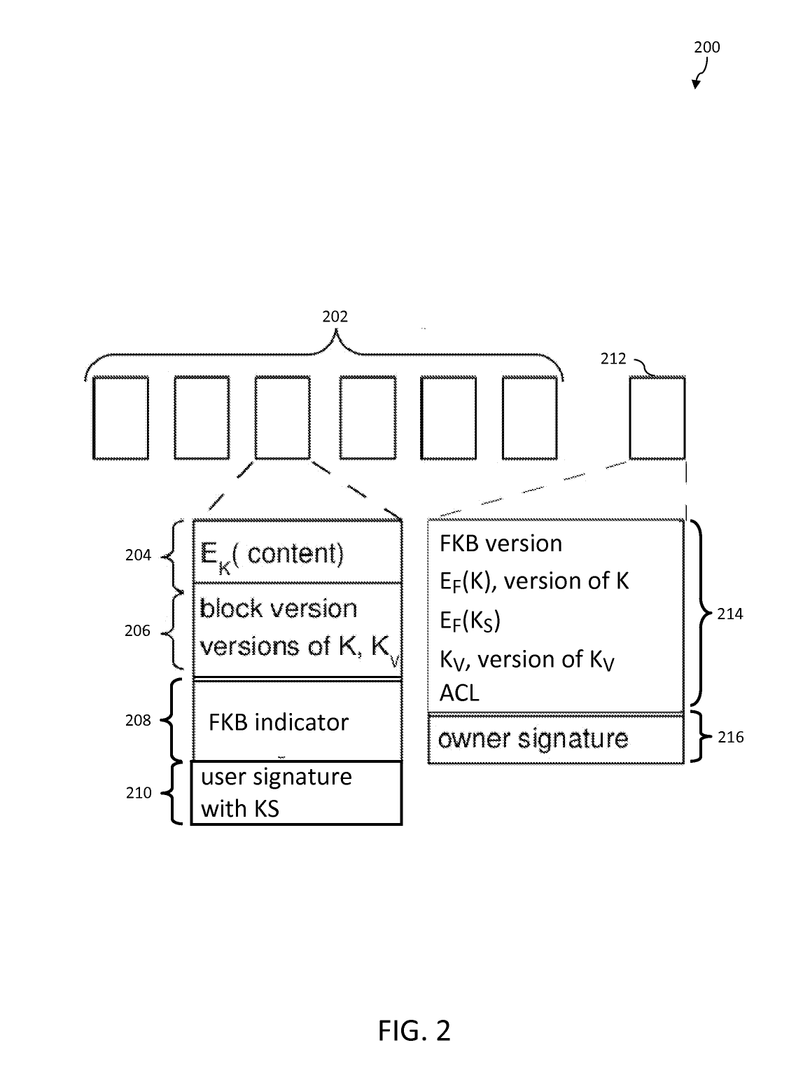

FIG. 2 depicts example configurations 200 of blocks in accordance with an embodiment. For instance, each block in block family 202 includes encrypted block content 204, block metadata 206, a family key block (FKB) indicator 208, and a signature 210. K represents the read access key; K_{S} represents the signing key; and K_{V} represents the verification key. The block version, which is referenced in block metadata 206, is an integer for each block that is incremented (e.g., by one) with every update to the block that is committed to a cloud service with respect to which the block is stored. FKB indicator 210 specifies family key block 212.

Family key block 212 includes encrypted information 214 and a signature 216 of the data owner of the block family 202. E_{F}( ) represents broadcast encryption to the authorized users in the ACL of the block family 202. For instance, using broadcast encryption, the data owner encrypts the read access key, so that only users and groups in the ACL's read set can decrypt the key. Accordingly, only the users and groups in the ACL's read set are able to decrypt the blocks in the corresponding block family 202. The data owner also uses broadcast encryption to encrypt the signing key so that only users and groups that are included in a write set of the ACL can decrypt the key. Accordingly, only the users and groups that are included in a write set of the ACL can generate update signatures for blocks in the corresponding block family 202.

The data owner may want to revoke access of some data users with respect to data that is owned by the data owner by removing those data users from group(s) or from individual block ACL(s). The data owner may use immediate revocation or lazy revocation to revoke access of a data user. In immediate revocation, the revoked user is not allowed to access any of the data from the moment of the revocation. In lazy revocation, the revoked user does not have access to any data blocks that have been updated after the revoked user's revocation.

When an ACL that is associated with a block changes, the block undergoes immediate revocation. For example, the block ceases to be associated with its former ACL and becomes associated with the new ACL. In accordance with this example, the block may be immediately re-encrypted with the read access key in the family key block that is associated with the new ACL.

In contrast, when a group's membership changes, all blocks with ACLs that include that group undergo revocation. Using immediate revocation in this case may be relatively expensive, because it involves immediately re-encrypting all the blocks in one or more block families, which potentially is a substantial amount of data. Furthermore, such an approach may be futile because a malicious revoked data user may have copied all the blocks for which the revoked data user had access. Accordingly, it may be desirable to use lazy revocation when a group's membership changes.

For instance, when a group's membership changes, the data owner may roll the keys forward to a new version for each of the families corresponding to the affected ACLs in accordance with a key rotation technique. The blocks with those ACLs need not necessarily be re-encrypted immediately. Rather, the blocks may be lazily re-encrypted. Accordingly, the work that the data owner is to perform upon a membership change is independent of the number of files in the block family. The data owner merely updates the family key blocks with the new key information. Broadcast encryption has complexity O(\sqrt{N}), where N is the number of members in the ACL.

When a user writes a block, that user checks whether the version of the read access key in the family key block is greater than that of the current read access key of the block. If it is, the user encrypts the block with the new key. Encrypting with a different key does not incur overhead because all writes may require encryption. Accordingly, the burden of the revocation is pushed to users, but without the users incurring overhead beyond that which is common for a data write operation.

The division of storage into block families may make revocation easier as compared to conventional revocation techniques. For example, in conventional revocation techniques, multiple Unix-like groups may be associated with a block. In accordance with this example, one may need to store encryptions of the signature and block encryption key for every group with each block. Besides the storage overhead, this may require many public key operations whenever a member leaves a group because the key may need to be changed for every block involving that group. Accordingly, such conventional techniques are likely to be slower and more complex than techniques that divide storage into block families.

Attestations allow data users to prove misbehavior of a cloud service provider 106. When a user system 102 performs a get operation with respect to a cloud service, a cloud service provider 106 that provides that cloud service provides a cloud get attestation to the user system 102. When a user system 102 performs a put operation with respect to the cloud service, the user system 102 provides a client put attestation to the cloud service provider 106, and the cloud service provider 106 returns a cloud put attestation to the user system 102. Such attestations serve to attest to the behavior of each party. For example, when the user system 102 performs a get operation, the cloud service provider 106 may attach to the response an attestation that certifies that the cloud service provider 106 is giving the user system 102 accurate data, which is specified by the get operation. When the user system 102 performs a put operation, the user system 102 provides a client put attestation to certify that the user system 102 is requesting that existing data be overwritten with content that is specified by the put operation. The cloud service provider 106 answers with a cloud put attestation that certifies that the content is committed with respect to the cloud service.

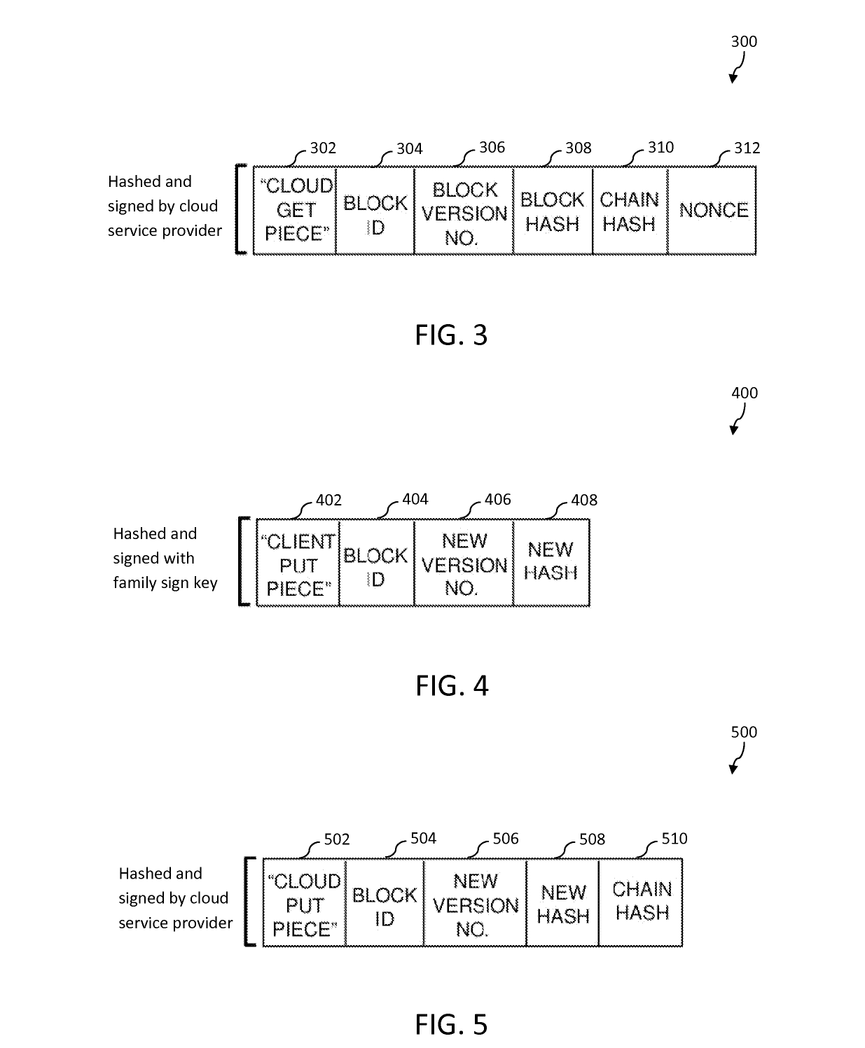

In accordance with example embodiments, an attestation includes a plurality of concatenated fields. For instance, the attestation may be hashed and signed. The signature may be used as a proof of a violation (or lack of a violation) of a security property. Accordingly, it may be desirable for the signatures to be non-repudiable (e.g., unique signatures). FIGS. 3-5 depict example attestations 300, 400, and 500 in accordance with embodiments. Attestation 300 of FIG. 3 corresponds to a get request. Attestations 400 and 500 of respective FIGS. 4 and 5 correspond to a put request.

As shown in FIG. 3, a cloud get piece attestation 300 includes a type field 302, a block ID field 304, a block version field 306, a block hash field 308, a chain hash field 310, and a nonce field 312. Type field 302 indicates a type of the attestation. For instance, the type may be a cloud get attestation, a client put attestation, or a cloud put attestation. For illustrative purposes, type field 302 indicates that attestation 300 is a cloud get attestation. For instance, if a user system 102 provides a get request to a cloud service provider 106, the cloud service provider 106 may provide attestation 300 to the user system 102 along with a block (and metadata thereof) that is specified in the get request.

Block ID field 304 indicates an identifier of a block with which attestation 300 is associated. For instance, the indicator of the block may be included in the get request that is received from the user system 102. Block version field 306 indicates a version number of the block that is identified by block ID field 304. For instance, each time a block is updated, the version number of the block may be incremented. Block hash field 308 includes a hash of the block that is identified by block ID field 304. For instance, the hash may be considered an abbreviated representation of the block. In accordance with example embodiments, block version field 306 and block hash field 308 may be used for purposes of proving (or disproving) write-serialization.

Chain hash field 310 includes a hash over data in the current attestation and the chain hash of the previous attestation for that block. Accordingly, the chain hash depends not only on the current attestation but also on the history of all previous attestations for the block. The chain hash may be represented as follows: chain hash=hash(data; previous chain hash). In accordance with example embodiments, chain hash field 310 is used for purposes of proving (or disproving) freshness. Nonce field 312 includes a randomly selected number that a user system 102 provides to a cloud service provider 106 that stores the block. For instance, the nonce field 312 may be used to hinder or prevent the cloud service provider 106 from generating attestation 300 before receiving the corresponding get request from the user system 102. As indicated in FIG. 3, attestation 300 is hashed and signed by the cloud service provider 106.

Upon receiving attestation 300 and the block from the cloud service provider 106, the user system 102 may verify attestation 300 and an integrity signature that is associated with the block to determine whether a violation of a security property has occurred.

As shown in FIG. 4, a client put piece attestation 400 includes a type field 402, a block ID field 404, a block version field 406, and a block hash field 408. For illustrative purposes, type field 402 indicates that attestation 400 is a client put attestation. As indicated in FIG. 4, attestation 400 is hashed and signed with a family sign key by a user system 102. For example, the user system 102 may provide a put request to a cloud service provider 106 that includes a block (including metadata thereof) and attestation 400. In accordance with this example, the cloud service provider 106 may hash the content of the block to determine whether the hashed content matches a new hash that is specified by block hash field 408. If a match occurs, the cloud service provider 106 stores the block and attestation 400.

As shown in FIG. 5, a cloud put piece attestation 500 includes a type field 502, a block ID field 504, a block version field 506, a block hash field 508, and a chain hash field 310. For illustrative purposes, type field 502 indicates that attestation 500 is a cloud put attestation. For instance, the cloud service provider 106 may provide attestation 500 to the user system 102 in response to determining that the content of the block that is received from the user system 102 with respect to the put request matches the new hash that is specified by block hash field 408 and is stored durably and consistently. Upon receiving attestation 500, the user system 102 may verify attestation 500.

The structure of attestations 300, 400, and 500 depends on the security level desired. For example, if the user does not want to monitor write-serialization and freshness of the user's data, cloud attestations 300 and 500 need not necessarily be used. In accordance with this example, client attestation 400 may be used for purposes of monitoring integrity. In another example, if the user does not want to monitor freshness but does want to monitor write-serialization, the chain hashes 310 and 510 may be removed from respective attestations 300 and 500.

If a cloud service provider 106 is malicious, the cloud service provider 106 may claim that it did not receive a put request from a user system 102 or that it sent a cloud put attestation to the user system 102 in response to the put request but the user system 102 missed it. In this case, the cloud service provider 106 has the choice of placing the put or not placing the put. If the cloud service provider 106 performs the update, it may defend against an accusation of a security violation by the user system 102 by showing the client put attestation. If the cloud service provider 106 does not perform the update, the user system 102 is unable to accuse the cloud service provider 106 of a violation, because the user system 102 does not have a cloud put attestation. It is possible for the cloud service provider 106 to attempt to mount a fork attack by accepting two writes for the same version. However, auditing techniques may be used to detect cloud misbehavior the moment two read operations complete to different contents of the block that have the same version number.

It may be desirable for a put exchange to be all-or-nothing. That is, either the put is placed (available to readers) and the user system 102 and the cloud service provider 106 receive the respective attestations, or the put is not placed and neither the user system 102 nor the cloud service provider 106 receives the respective attestations. This facilitates reasoning about the correctness of the protocol and allows auditing for write-serialization to be conducted entirely based on write attestations (rather than read attestations which are more numerous). It should be recognized that the security guarantees of integrity, write-serialization, and freshness hold without this all-or-nothing protocol. Thus, making a put exchange all-or-nothing is optional.

Some relatively minor changes may be made to the get and put protocols to make a put exchange all-or-nothing. The put protocol may be modified so that the user system 102 sends to the cloud service provider 106 a client confirmation. The client confirmation is a signed hash of the client put attestation (e.g., client put attestation 400) concatenated with an indicator that specifies that the user system 102 received the cloud put attestation (e.g., cloud put attestation 500). This modification to the put protocol may be performed in the background.

The get protocol may be modified such that the cloud service provider 106 sends a confirmation from the most recent writer to the user system 102. If the cloud service provider 106 did not receive a confirmation from the most recent writer, the cloud service provider 106 may send the cloud put attestation for that write operation. The user system 102 may verify the confirmation or attestation for the most recent write. This modification to the get protocol may not add any round trip times to the overhead.

For every put to a block for which a get operation completes, a member of the block's read or write ACL has the cloud attestation, and the cloud service provider 106 has the client attestation for the version of the block read. If the get completes correctly, it follows that the integrity signature on the block verified. This is the same with the client attestation, so it may be presumed that the cloud service provider 106 received the client attestation. If the get succeeds, it may be presumed that the cloud provided a confirmation or the cloud attestation. A confirmation means that a writer received the cloud attestation.

Time may be divided into epochs for purposes of auditing. An epoch is a fixed time period (e.g., 8 hours, one day, three days, a week, a month, six months, etc.). Epochs may be consecutively numbered, for example “epoch 0, epoch 1, epoch 2,” and so on. At the end of an epoch, a data owner may perform auditing to determine whether a security property is violated. The end of an epoch is also when the data owner may perform membership changes (e.g., addition or removal of ACL members) that were requested during the epoch. Each block has a corresponding probability of being audited in an epoch. During the epoch, users of a cloud service send to the data owner attestations that are received from a cloud service provider 106 that provides the cloud service. The data owner may use these attestations to construct a proof, which may be used to convince a third party if misbehavior of the cloud is detected.

Auditing techniques described herein are capable of verifying the freshness and/or write-serialization of the data. For instance, confidentiality and integrity may be verified separately. User systems 102A-102X are unable to forge an invalid attestation because a corresponding signature is not forgeable. If a user system falsely claims that a different verification key should be used, the cloud service provider 106 may exhibit the owner's attestation for the key block. This suffices for verification because the data block and the key block include the version of the verification key.

The data owner may assign to each block some probability of auditing, so an audit need not necessarily check every block for every epoch. If a block is relatively sensitive, the data owner can assign it a relatively greater probability (e.g., 93%, 100%, etc.). A probability of 100% means that the block is audited in every epoch. If a block is not very important, the owner can assign it a relatively lesser probability, perhaps even zero.

If a cloud service provider 106 is allowed to know exactly which epochs are to feature an audit of a block, the cloud service provider 106 may be able to undetectably misbehave with regard to that block during epochs that are not to feature an audit of the block. Accordingly, it may be desirable not to inform the cloud service provider 106 which epochs are to feature an audit of the block.

User systems 102A-102X, in contrast, are to be privy to these epochs because they are to send attestations to the data owner in these epochs. Thus, a technique may be used to ensure that only user systems that know the read access key for a block can determine the epochs in which the block is to be audited. For instance, a block may be audited whenever hash(epoch number, block ID, read access key) mod L=0, where L is an integer included in plain text in the block metadata by the data owner. If a probability of audit P is desired, the data owner can achieve this by setting L=1/P.

When a block is meant to be audited, user systems 102A-102X send the data owner the attestations they received from the cloud service provider 106. The data owner separates these attestations by block and sorts them by version number. This may utilize an insubstantial amount of processing because the attestations likely arrive in approximately this order. The attestations for the same version number are sorted such that each two consecutive attestations satisfy the equation: chain hash=hash(data; previous chain hash). For instance, the cloud service provider 106 may attach a sequence number to the attestations to facilitate this sorting. If attestations are missing from the series, the data owner may ask the cloud service provider 106 to provide them. If the cloud service provider 106 is unable to provide them, the cloud service provider 106 may be penalized for non-compliance with the auditing procedure. Once the data owner has the complete sequence of attestations, it performs checks for write-serialization and/or freshness.

After completion of auditing, the data owner and the cloud service provider 106 may create a Merkle hash of the entire storage, exchange attestations that they agree on the same Merkle value, and discard all attestations from the epoch that just ended. The Merkle hash can be computed efficiently using the hashes of the blocks that were modified and the hashes of the roots of the blocks that were not modified in the present epoch.

The data owner also updates the family key blocks if there were any membership changes.

During the epoch, the cloud service provider 106 is responsible for maintaining write-serialization of the data. That is, the cloud service provider 106 may ensure that every put advances the version number of the most recently stored block by a predetermined amount (e.g., one). If a user system 102 provides a put for an old version number, the cloud service provider 106 may inform the user system 102 of such conflict. The user system 102 may determine an action to take (e.g., give up on its own change, apply the changes of which the cloud service provider 106 informs the user system 102, merge the files, etc.).

One type of attack on write-serialization is a fork attack. A fork attack involves the cloud service provider 106 providing inconsistent views to different user systems, for example, by copying the data and performing some writes on the original data and a different set of writes on the copy. A correct write chain of attestations is a chain where there is exactly one write for every version number between the least and the greatest in the sequence.

A first theorem provides that the cloud service provider 106 satisfies write-serialization of a block in an epoch if and only if the write attestations of the cloud service provider 106 form one correct write chain. The theorem assumes that the all-or-nothing protocol is used and that user systems send all the read and write attestations that they receive from the cloud service provider 106 to the owner. If the user systems do not send all these attestations, the theorem holds for every complete interval of version numbers for which attestations are sent. If the all-or-nothing protocol is not used, the theorem assumes that all user systems send their read attestations to the enterprise. In this case, the theorem may be modified to require the read attestations to form a chain. For instance, if the cloud service provider 106 satisfies write-serialization, it may make sure that there are no multiple writes for the same version number and no version number is skipped; therefore, the attestations form a correct chain.

A violation of write-serialization occurs when a user system 102 performs an update to an old version of data. Assume for purposes of illustration that the current version of the data that is stored by a cloud service provider 106 is n and the user system 102 is aware of m<n. When the user system 102 places a put, the version number he uses is m+1≦n. Further assume that the cloud service provider 106 accepts this version and provides a cloud attestation for m+1. Because m+1≦n, another put with version m+1 committed. If that put changed the block in a different way (thus inducing a different new hash in the attestation), the data owner may observe that the attestations split at m+1. If the all-or-nothing protocol is not used, the data owner may observe that read attestations to the conflicting writes contain the same version number but different hashes. The broken sequence of write attestations and the cloud attestation for the current family key block may be used to prove a violation of write-serialization, because cloud attestations are not forgeable.

During the epoch, the cloud service provider 106 is supposed to respond to each get request with the latest committed put content and compute chain hashes based on the most recent chain hash for every cloud attestation. A correct chain of attestations is a correct write chain in which (1) the hash in each read attestation equals the new hash in the write attestation with the same version number and (2) the chain hash for an attestation and the chain hash of the previous attestation in the sequence satisfy the equation: chain hash=hash(data; previous chain hash).

A second theorem provides that the cloud service provider 106 satisfies freshness if and only if the attestations form one correct chain. Each chain hash that the cloud service provider 106 gives to a user system may be dependent on some unpredictability (e.g., randomness) the user system provides. Such unpredictability may be provided in the form of a nonce for a get operation or a new hash for a put operation. The value of a chain hash recursively depends on all the history of chain hashes before it.

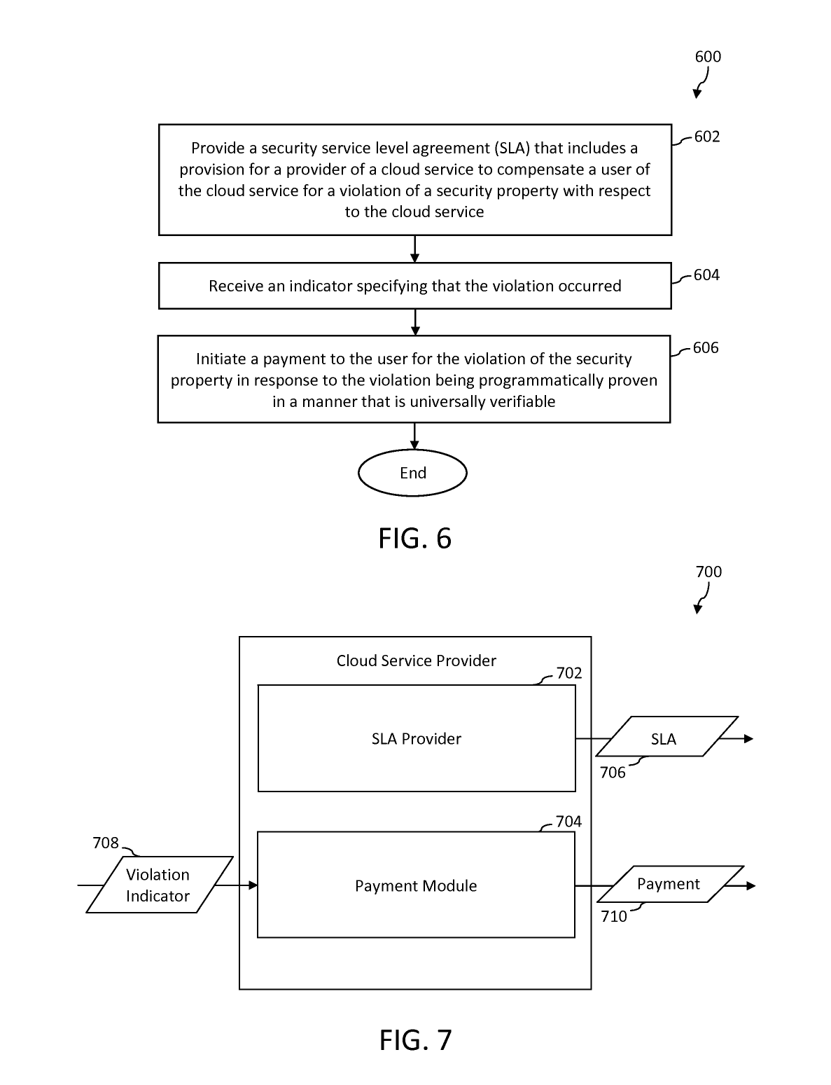

FIG. 6 depicts a flowchart 600 of an example method for compensating a user for a violation of a security property with respect to a cloud service in accordance with an embodiment. Flowchart 600 is described from the perspective of a cloud service provider. Flowchart 600 may be performed by any one or more of cloud service providers 106A-106Y of cloud service system 100 shown in FIG. 1, for example. For illustrative purposes, flowchart 600 is described with respect to a cloud service provider 700 shown in FIG. 7, which is an example of a cloud service provider 106, according to an embodiment. As shown in FIG. 7, cloud service provider 700 includes an SLA provider 702 and a payment module 704. Further structural and operational embodiments will be apparent to persons skilled in the relevant art(s) based on the discussion regarding flowchart 600. Flowchart 600 is described as follows.

As shown in FIG. 6, the method of flowchart 600 begins at step 602. In step 602, a security service level agreement (SLA) is provided that includes a provision for a provider of a cloud service to compensate a user of the cloud service for a violation of a security property with respect to the cloud service. Examples of a security property include but are not limited to confidentiality, integrity, write-serialization, freshness, etc. In an example implementation, SLA provider 702 provides SLA 706 that includes a provision for a provider of a cloud service to compensate a user of the cloud service for a violation of a security property with respect to the cloud service.

At step 604, an indicator specifying that the violation occurred is received. In an example implementation, payment module 704 receives violation indicator 708 that specifies that the violation occurred.

At step 606, a payment to the user is initiated for the violation of the security property in response to the violation being programmatically proven in a manner that is universally verifiable. For example, the payment may be initiated based on an attestation that is appended to data that is transferred between the user and the provider not satisfying at least one designated correctness (e.g., cryptographic) criterion. In an example implementation, payment module 704 initiates payment 710 to the user for the violation of the security property in response to the violation being programmatically proven in a manner that is universally verifiable, e.g., by third parties.

In some example embodiments, the security property that is mentioned in the provision of the security SLA is freshness. In a first aspect of such embodiments, the method of flowchart 600 may further include receiving a get request from the user and providing a response to the user. The response may include data that is specified in the get request and an attestation that includes a chain hash. In accordance with the first aspect, step 606 may include initiating the payment to the user in response to the chain hash not satisfying at least one designated correctness (e.g., cryptographic) criterion. In a second aspect, the method of flowchart 600 may further include receiving a put request from the user and providing an attestation that includes a chain hash in response to receiving the put request. In accordance with the second aspect, step 606 may include initiating the payment to the user in response to the chain hash not satisfying at least one designated correctness criterion.

In some example embodiment, the security property that is mentioned in the provision of the security SLA is write-serialization. In a first aspect of such embodiments, the method of flowchart 600 may further include receiving a get request from the user and providing a response to the user. The response may include data that is specified in the get request and an attestation that includes a block version number and a block hash. In accordance with the first aspect, step 606 may include initiating the payment to the user in response to at least one of the block version number or the block hash not satisfying a respective at least one designated correctness criterion. In a second aspect, the method of flowchart 600 may further include receiving a put request from the user and providing an attestation that includes a block version number and a block hash to the user in response to receiving the put request. In accordance with the second aspect, step 606 may include initiating the payment to the user in response to at least one of the block version number or the block hash not satisfying a respective at least one designated correctness criterion.

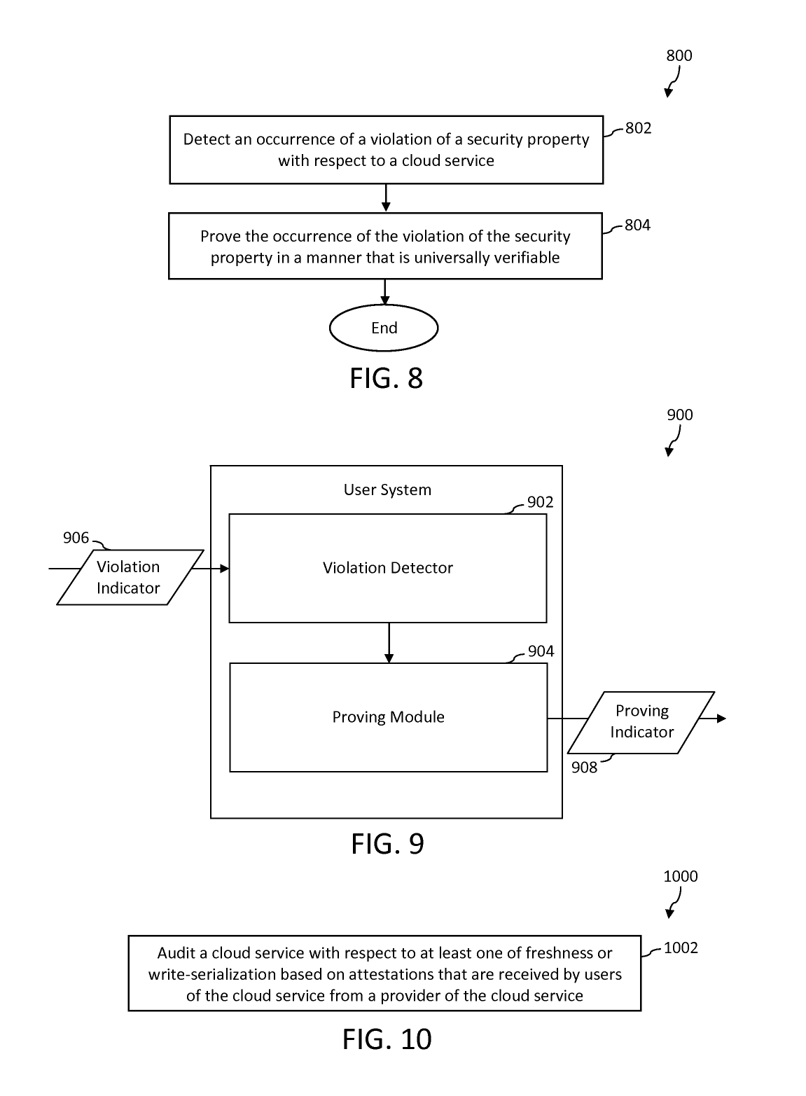

FIG. 8 depicts a flowchart 800 of an example method for proving an occurrence of a violation of a security property in accordance with an embodiment. Flowchart 800 is described from the perspective of a user system. Flowchart 800 may be performed by any one or more of user systems 102A-102X of cloud service system 100 shown in FIG. 1, for example. For illustrative purposes, flowchart 800 is described with respect to a user system 900 shown in FIG. 9, which is an example of a user system 102, according to an embodiment. As shown in FIG. 9, user system 900 includes a violation detector 902 and a proving module 904. Further structural and operational embodiments will be apparent to persons skilled in the relevant art(s) based on the discussion regarding flowchart 800. Flowchart 800 is described as follows.

As shown in FIG. 8, the method of flowchart 800 begins at step 802. In step 802, an occurrence of a violation of a security property with respect to a cloud service is detected. In an example implementation, violation detector 902 detects the occurrence of the violation of the security property with respect to the cloud service. For instance, violation detector 902 may interpret violation indicator 906 to determine that the violation has occurred.

At step 804, the occurrence of the violation of the security property is proven in a manner that is universally verifiable. For example, the occurrence of the violation of the security property may be proven based on an attestation that is appended to data that is transferred between the user and the provider not satisfying at least one designated correctness (e.g., cryptographic) criterion. In an example implementation, proving module 904 proves the occurrence of the violation in a manner that is universally verifiable, e.g., by third parties. For example, proving module 904 may provide proving indicator 908 to prove the occurrence of the violation. In accordance with this example, proving indicator 908 may include a cloud get attestation (e.g., attestation 300) and/or a cloud put attestation (e.g., attestation 500).

In some example embodiments, the security property that is mentioned in the provision of the security SLA is freshness. In a first aspect of such embodiments, the method of flowchart 800 may further include providing a get request to the provider and receiving a response from the provider. The response may include data that is specified in the get request and an attestation that includes a chain hash. In accordance with the first aspect, step 804 may include providing a violation indicator that specifies that the chain hash does not satisfy at least one designated correctness criterion. In a second aspect, the method of flowchart 800 may further include providing a put request to the provider and receiving an attestation that includes a chain hash from the provider in response to providing the put request. In accordance with the second aspect, step 804 may include providing a violation indicator that specifies that the chain hash does not satisfy at least one designated correctness criterion.

In some example embodiment, the security property that is mentioned in the provision of the security SLA is write-serialization. In a first aspect of such embodiments, the method of flowchart 800 may further include providing a get request to the provider and receiving a response from the provider. The response may include data that is specified in the get request and an attestation that includes a block version number and a block hash. In accordance with the first aspect, step 804 may include providing a violation indicator that specifies that at least one of the block version number or the block hash does not satisfy a respective at least one designated correctness criterion. In a second aspect, the method of flowchart 800 may further include providing a put request to the provider and receiving an attestation that includes a block version number and a block hash from the provider in response to providing the put request. In accordance with the second aspect, step 804 may include providing a violation indicator that specifies that at least one of the block version number or the block hash does not satisfy a respective at least one designated correctness criterion.

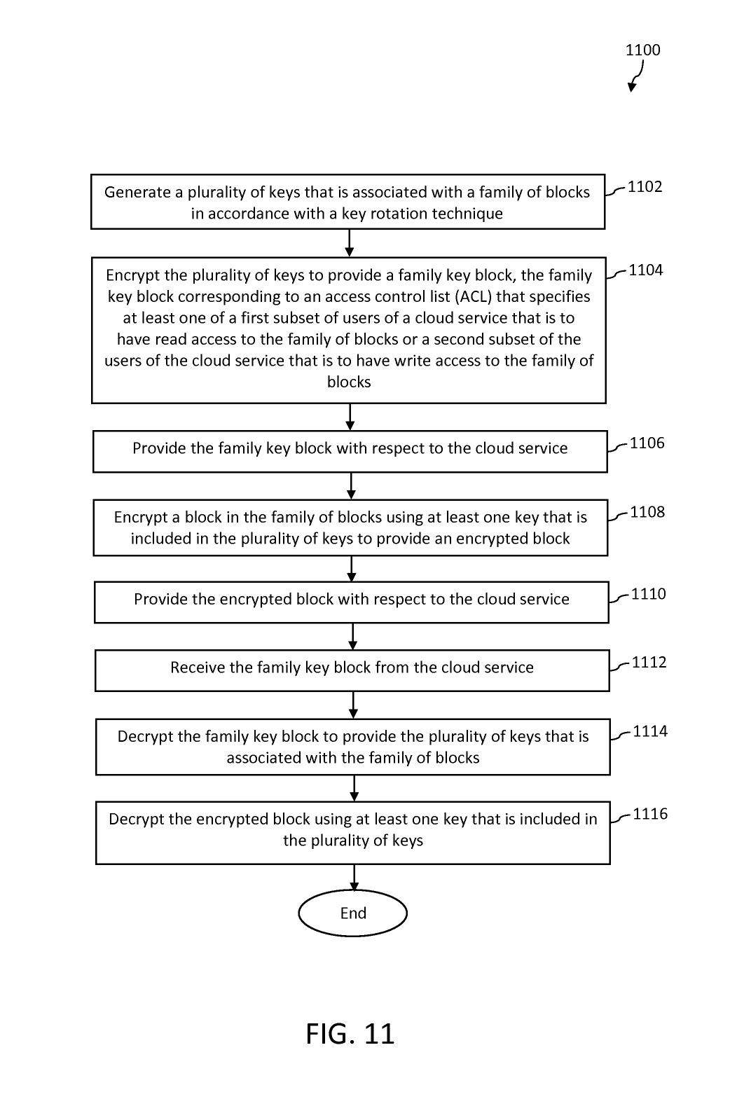

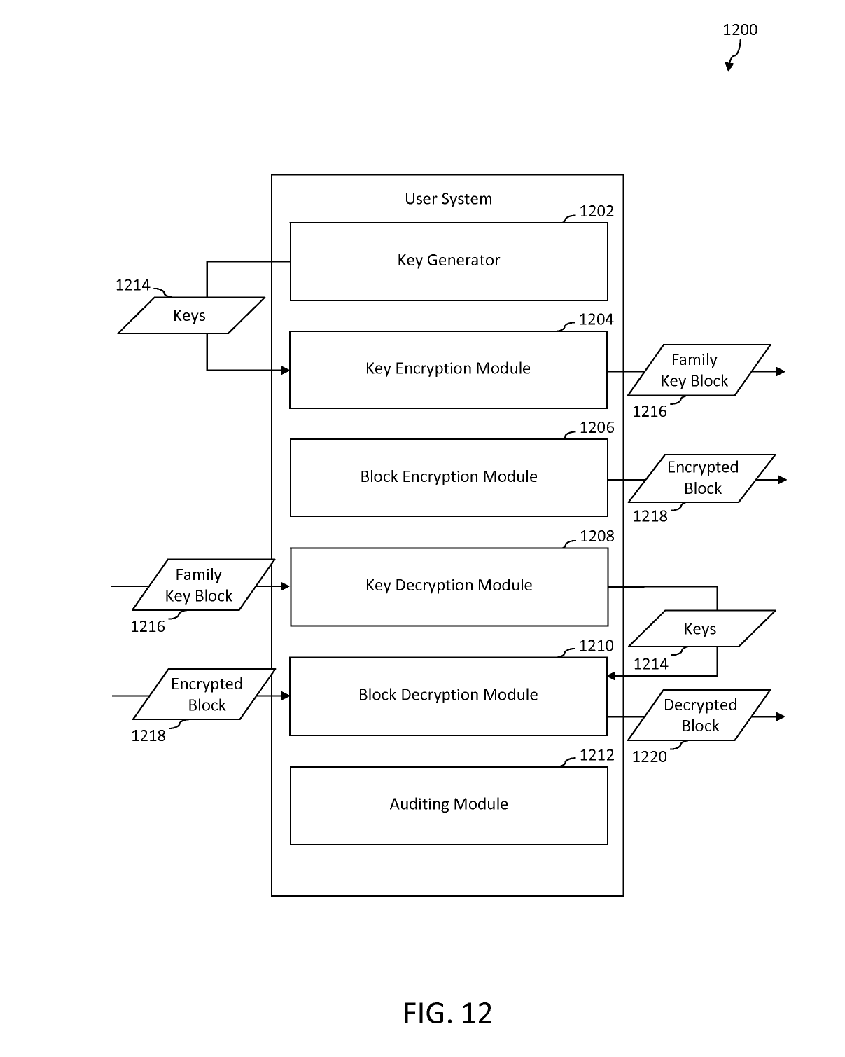

FIG. 10 depicts a flowchart of an example method for auditing a cloud service in accordance with an embodiment. FIG. 11 depicts a flowchart 1100 of an example method for accessing a block in accordance with an embodiment. Flowcharts 1000 and 1100 are described from the perspective of a user system. Each of flowcharts 1000 and 1100 may be performed by any one or more of user systems 112A-102X of cloud service system 110 shown in FIG. 1, for example. For illustrative purposes, flowcharts 1000 and 1100 are described with respect to a user system 1200 shown in FIG. 12, which is an example of a user system 102, according to an embodiment. As shown in FIG. 12, user system 1200 includes a key generator 1202, a key encryption module 1204, a block encryption module 1206, a key decryption module 1208, a block decryption module 1210, and an auditing module 1212. Further structural and operational embodiments will be apparent to persons skilled in the relevant art(s) based on the discussion regarding flowcharts 1000 and 1100.

As shown in FIG. 10, the method of flowchart 1000 includes step 1002. At step 1102, a cloud service is audited with respect to at least one of freshness or write serialization based on attestations that are received by users of the cloud service from a provider of the cloud service. In an example implementation, auditing module 1212 audits the cloud service with respect to freshness and/or write-serialization based on the attestations.

As shown in FIG. 11, the method of flowchart 1100 begins at step 1102. In step 1102, a plurality of keys that is associated with a family of blocks is generated in accordance with a key rotation technique. The plurality of keys may include any suitable types of keys, including but not limited to a read access key, a signing key, a verification key, etc. In an example implementation, key generator 1202 generates keys 1214 that are associated with a family of blocks in accordance with a key rotation technique.

At step 1104, the plurality of keys is encrypted to provide a family key block. The family key block corresponds to an access control list (ACL) that specifies at least one of a first subset of the users of a cloud service that is to have read access to the family of blocks or a second subset of the users of the cloud service that is to have write access to the family of blocks. The plurality of keys may be encrypted in accordance with any suitable encryption technique (e.g., a broadcast encryption technique). In an example implementation, key encryption module 1204 encrypts keys 1214 to provide family key block 1216.

At step 1106, the family key block is provided with respect to the cloud service. In an example implementation, key encryption module 1204 provides family key block 1216 with respect to the cloud service.

At step 1108, a block in the family of blocks is encrypted using at least one key (e.g., a read access key) that is included in the plurality of keys to provide an encrypted block. In an example implementation, block encryption module 1206 encrypts a block in the family of blocks using at least one of keys 1214 to provide encrypted block 1218.

At step 1110, the encrypted block is provided with respect to the cloud service. In an example implementation, block encryption module 1206 provides encrypted block 1218 with respect to the cloud service.

At step 1112, the family key block is received from the cloud service. In an example implementation, key decryption module 1208 receives family key block 1216 from the cloud service. In some example embodiments, the family key block need not necessarily be received from the cloud service. For instance, key decryption module 1208 may store the family key block for processing at step 1114, which is described below.

At step 1114, the family key block is decrypted to provide the plurality of keys that is associated with the family of blocks. In an example implementation, key decryption module 1208 decrypts family key block 1216 to provide keys 1214, which are associated with the family of blocks.

At step 1116, the encrypted block is decrypted using at least one key (e.g., a read access key) that is included in the plurality of keys. In an example implementation, block decryption module 1210 decrypts encrypted block 1218 using at least one of keys 1214 to provide decrypted block 1220. For instance, block decryption module 1210 may receive encrypted block 1218 from the cloud service.

In some example embodiments, one or more steps 1102, 1104, 1106, 1108, 1110, 1112, 1114, and/or 1116 of flowchart 1100 may not be performed. Moreover, steps in addition to or in lieu of steps 1102, 1104, 1106, 1108, 1110, 1112, 1114, and/or 1116 may be performed.

It will be recognized that user system 1200 may not include one or more of key generator 1202, key encryption module 1204, block encryption module 1206, key decryption module 1208, block decryption module 1210, and/or auditing module 1212. Furthermore, user system 1200 may include modules in addition to or in lieu of key generator 1202, key encryption module 1204, block encryption module 1206, key decryption module 1208, block decryption module 1210, and/or auditing module 1212.

SLA provider 702, payment module 704, violation detector 902, proving module 904, key generator 1202, key encryption module 1204, block encryption module 1206, key decryption module 1208, block decryption module 1210, and auditing module 1212 may be implemented in hardware, software, firmware, or any combination thereof. For example, SLA provider 702, payment module 704, violation detector 902, proving module 904, key generator 1202, key encryption module 1204, block encryption module 1206, key decryption module 1208, block decryption module 1210, and/or auditing module 1212 may be implemented as computer program code configured to be executed in one or more processors. In another example, SLA provider 702, payment module 704, violation detector 902, proving module 904, key generator 1202, key encryption module 1204, block encryption module 1206, key decryption module 1208, block decryption module 1210, and/or auditing module 1212 may be implemented as hardware logic/electrical circuitry.

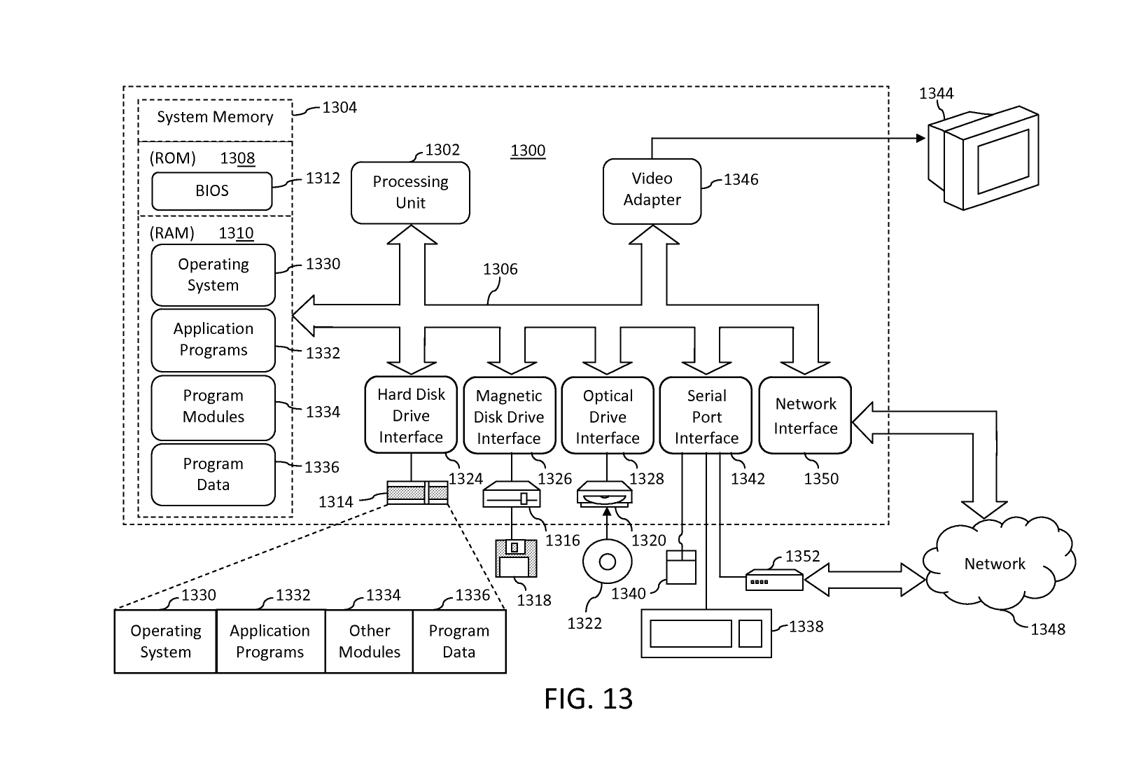

FIG. 13 depicts an example computer 1300 in which embodiments may be implemented. Any one or more of the user systems 102A-102X (or any one or more subcomponents thereof shown in FIGS. 9 and 12) or the cloud service providers 106A-106Y shown in FIG. 1 (or any one or more subcomponents thereof shown in FIG. 7) may be implemented using computer 1300, including one or more features of computer 1300 and/or alternative features. Computer 1300 may be a general-purpose computing device in the form of a conventional personal computer, a mobile computer; or a workstation, for example, or computer 1300 may be a special purpose computing device. The description of computer 1300 provided herein is provided for purposes of illustration, and is not intended to be limiting. Embodiments may be implemented in further types of computer systems, as would be known to persons skilled in the relevant art(s).

As shown in FIG. 13, computer 1300 includes a processing unit 1302, a system memory 1304, and a bus 1306 that couples various system components including system memory 1304 to processing unit 1302. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random access memory (RAM) 1310. A basic input/output system 1312 (BIOS) is stored in ROM 1308.

Computer 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical, disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1330, one or more application programs 1332, other program modules 1334, and program data 1336. Application programs 1332 or program modules 1334 may include, for example, computer program logic for implementing SLA provider 702, payment module 704, violation detector 902, proving module 904, key generator 1202, key encryption module 1204, block encryption module 1206, key decryption module 1208, block decryption module 1210, auditing module 1212, flowchart 600 (including any step of flowchart 600), flowchart 800 (including any step of flowchart 800), flowchart 1000, and/or flowchart 1100 (including any step of flowchart 1100), as described herein.

A user may enter commands and information into the computer 1300 through input devices such as keyboard 1338 and pointing device 1340. Other input devices (not shown) may include a microphone, joystick, game pad, satellite dish, scanner, or the like. These and other input devices are often connected to the processing unit 1302 through a serial port interface 1342 that is coupled to bus 1306, but may be connected by other interfaces, such as a parallel port, game port, or a universal serial bus (USB).

A display device 1344 (e.g., a monitor) is also connected to bus 1306 via an interface, such as a video adapter 1346. In addition to display device 1344, computer 1300 may include other peripheral output devices (not shown) such as speakers and printers.

Computer 1300 is connected to a network 1348 (e.g., the Internet) through a network interface or adapter 1350, a modem 1352, or other means for establishing communications over the network. Modem 1352, which may be internal or external, is connected to bus 1306 via serial port interface 1342.

As used herein, the terms “computer program medium” and “computer-readable medium” are used to generally refer to media such as the hard disk associated with hard disk drive 1314, removable magnetic disk 1318, removable optical disk 1322, as well as other media such as flash memory cards, digital video disks, random access memories (RAMs), read only memories (ROM), and the like.

As noted above, computer programs and modules (including application programs 1332 and other program modules 1334) may be stored on the hard disk, magnetic disk, optical disk, ROM, or RAM. Such computer programs may also be received via network interface 1350 or serial port interface 1342. Such computer programs, when executed or loaded by an application, enable computer 1300 to implement features of embodiments discussed herein. Accordingly, such computer programs represent controllers of the computer 1300.

Example embodiments are also directed to computer program products comprising software (e.g., computer-readable instructions) stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

### III. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described example embodiments, but should be defined only in accordance with the following claims and their equivalents.

What is claimed is:

1. A method comprising:
providing a security service level agreement that includes a provision for a provider of a cloud service to compensate a user of the cloud service for a violation of a security property with respect to the cloud service; and
initiating a payment to the user, at a payment module using one or more processors of the payment module, for the violation of the security property in response to the violation being programmatically proven in a manner that is universally verifiable.

2. The method of claim 1, wherein initiating the payment to the user comprises:
initiating the payment to the user for the violation of the security property in response to the violation being programmatically proven based on at least one attestation that is appended to data that is transferred between the user and the provider not satisfying at least one designated correctness criterion.

3. The method of claim 1, wherein the security property includes freshness of data that is stored with respect to the cloud service.

4. The method of claim 3, further comprising:
receiving a get request from the user; and
providing a response to the user, the response including data that is specified in the get request and an attestation that includes a specified chain hash;
wherein initiating the payment to the user comprises:
initiating the payment to the user in response to the specified chain hash not satisfying at least one designated correctness criterion.

5. The method of claim 1, wherein the security property includes write-serialization of updates to data that is stored with respect to the cloud service.

6. The method of claim 5, further comprising:
receiving a get request from the user; and
providing a response to the user, the response including data that is specified in the get request and an attestation that includes a block version number and a block hash;
wherein initiating the payment to the user comprises:
initiating the payment to the user in response to at least one of the block version number or the block hash not satisfying a respective at least one designated correctness criterion.

7. The method of claim 5, further comprising:
receiving a put request from the user; and
providing an attestation that includes a block version number and a block hash to the user in response to receiving the put request;
wherein initiating the payment to the user comprises:
initiating the payment to the user in response to at least one of the block version number or the block hash not satisfying a respective at least one designated correctness criterion.

8. A method comprising:
detecting an occurrence of a violation of a security property with respect to a cloud service; and
proving the occurrence of the violation of the security property, at a proof module using one or more processors of the proof module, in a manner that is universally verifiable.

9. The method of claim 8, wherein proving the occurrence of the violation comprises:
proving the occurrence of the violation of the security property based on at least one attestation that is appended to data that is transferred between the user and the provider not satisfying at least one designated correctness criterion.

10. The method of claim 8, wherein the security property includes freshness of data that is stored with respect to the cloud service.

11. The method of claim 10, further comprising:
providing a get request to the provider; and
receiving a response from the provider, the response including data that is specified in the get request and an attestation that includes a chain hash;
wherein proving the occurrence of the violation of the security property comprises:
providing a violation indicator that specifies that the chain hash does not satisfy at least one designated correctness criterion.

12. The method of claim 10, further comprising:
providing a put request to the provider; and
receiving an attestation that includes a chain hash from the provider in response to providing the put request;
wherein proving the occurrence of the violation of the security property comprises:
providing a violation indicator that specifies that the chain hash does not satisfy at least one designated correctness criterion.

13. The method of claim 8, wherein the security property includes write-serialization of updates to data that is stored with respect to the cloud service.

14. The method of claim 13, further comprising:
providing a get request to the provider; and
receiving a response from the provider, the response including data that is specified in the get request and an attestation that includes a block version number and a block hash;
wherein proving the occurrence of the violation of the security property comprises:
providing a violation indicator that specifies that at least one of the block version number or the block hash does not satisfy a respective at least one designated correctness criterion.

15. The method of claim 13, further comprising:
providing a put request to the provider; and
receiving an attestation that includes a block version number and a block hash from the provider in response to providing the put request;
wherein proving the occurrence of the violation of the security property comprises:
providing a violation indicator that specifies that at least one of the block version number or the block hash does not satisfy a respective at least one designated correctness criterion.

16. A method comprising:
generating a plurality of keys that is associated with a family of blocks in accordance with a key rotation technique;
encrypting the plurality of keys to provide a family key block, the family key block corresponding to an access control list that specifies at least one of a first subset of users of a cloud service that is to have read access to the family of blocks or a second subset of the users of the cloud service that is to have write access to the family of blocks;
providing the family key block with respect to the cloud service;
encrypting a block in the family of blocks, at an encryption module using one or more processors of the encryption module, using at least one key that is included in the plurality of keys to provide an encrypted block; and
providing the encrypted block with respect to the cloud service.

17. The method of claim 16, further comprising:
receiving the family key block from the cloud service;
decrypting the family key block to provide the plurality of keys that is associated with the family of blocks; and
decrypting the encrypted block using at least one key that is included in the plurality of keys.

18. The method of claim 16, wherein generating the plurality of keys comprises:
generating a read access key that is associated with the family of blocks in accordance with the key rotation technique;
wherein encrypting the key comprises:
encrypting the read access key to provide the family key block; and
wherein encrypting the block comprises:
encrypting the block in the family of blocks using the read access key to provide the encrypted block.

19. The method of claim 16, wherein generating the plurality of keys comprises:
generating a signing key that is associated with the family of blocks in accordance with the key rotation technique;
wherein encrypting the key comprises:
encrypting the signing key to provide the family key block; and
wherein encrypting the block comprises:
encrypting the block in the family of blocks using the signing key to provide the encrypted block.

20. The method of claim 16, further comprising:
auditing the cloud service with respect to at least one of freshness or write-serialization based on attestations that are received by a plurality of users of the cloud service from a provider of the cloud service.
